(19) United States
(12) Patent Application Publication
(10) Pub. No.: US 2023/0001437 A1
(43) Pub. Date: Jan. 5, 2023

(54) Multiple Nozzle Aerosol Dispensing Container

(71) Applicant: Josef Farhi, Brooklyn, NY (US)

(72) Inventor: Josef Farhi, Brooklyn, NY (US)

(21) Appl. No.: 17/364,907

(22) Filed: Jul. 1, 2021

(51) Int. Cl. B05B 11/00; A45D 34/02; B65D 83/68

(52) U.S. Cl. CPC B05B 11/3084; A45D 34/02; B05B 11/00416; B65D 83/68; B05B 11/0054; A45D 2200/057

(57) ABSTRACT

The present disclosure discloses a multiple nozzle perfume dispensing container comprising: a body extending horizontally divided into at least two chambers separate from each other configured to contain at least two perfume products in each of the at least two chambers; at least two nozzle heads associated with each of the at least two separate chambers for spraying each of the at least two perfume products when twisted in anti-clockwise direction along with pressing of each of the two nozzle heads downward. Each of the at least two nozzle heads comprise: actuator components; at least two nozzles; and at least two pipes. The container further comprises at least two caps associated with the at least two nozzle heads for covering each of the nozzle head by twisting in a first direction and uncovering the one of the at least two nozzle heads by twisting in a second direction.

### BACKGROUND

### Field of Invention

The present disclosure relates to aerosol containers. More particularly, the present invention relates to a container adapted to refill multicomponent products, and especially perfumes.

### Description of Related Art

Aerosol containers are commonly used to store and dispense a product such as air freshening agents, deodorants, insecticides, germicides, decongestants, perfumes, or any other known products suitable for dispersal in the form of particles or droplets suspended within a gas. Most aerosol containers have one chamber containing both a propellant and an active composition. Some aerosol containers dispense the propellant and the active composition from separate containers. Further, many more types of liquid applicating containers have been devised for dispensing the aerosols.

Many traditional dispensing containers are configured to contain only one product, and therefore can only distribute one product. In the case of perfume-dispensing containers, the constant dispensing of a single perfume can quickly become tiresome for a user, especially as the desire for a specific perfume can vary throughout the day, or from one day to the next.

Therefore, there is a need for implementation of improved method and system for efficient and reliable package delivery, while ensuring the privacy of the customer and the customer's trusted individual.

### SUMMARY

Embodiments in accordance with the present invention provide a multiple nozzle perfume dispensing container. The container includes a body extending horizontally divided into at least two chambers separate from each other configured to contain at least two perfume products in each of the at least two chambers. The container also includes at least two nozzle heads associated with each of the at least two separate chambers for spraying each of the at least two perfume products when twisted in anti-clockwise direction along with pressing of each of the two nozzle heads downward, and the dispersion of one of the at least two perfume products stored in each of the at least two chambers are stopped when one of the at least two nozzle heads is twisted in a reverse direction opposite to the anti-clockwise direction. The nozzle heads include actuator components having a first actuator component associated with a first valve and a second actuator component associated with a second valve. Each of the at least two nozzle heads spray each of the at least two perfume products when each of the actuator components triggers the opening of the first valve, the second valve, and so forth. The nozzle heads also include at least two nozzles having spraying holes disposed at an upper portion for facilitating dispersion of each of the at least two perfume products stored in each of the at least two chambers when one of the actuator component is pushed down by a user to spray one of the at least two perfume products out of one of the at least two chambers, and stopping the dispensing of each of the at least two perfume products stored in each of the at least two chambers when each of the at least two nozzles twist in the anti-clockwise direction. The nozzle heads also include at least two pipes associated with each of the at least two nozzles to carry each of the at least two perfume products associated with each of the at least two chambers. The container further includes at least two caps associated with the at least two nozzle heads for covering each of the nozzle head by twisting in a first direction and uncovering the one of the at least two nozzle heads by twisting in a second direction.

Embodiments in accordance with the present invention provide an aerosol dispensing container. The container includes a body extending vertically includes protruding parts and plurality of chambers separate from each other through a partition. The plurality of chambers configured to contain plurality of aerosols in each of the plurality of chambers. The container also includes plurality of nozzle heads associated with each of the plurality of chambers for spraying each of the plurality of aerosols when twisted in anti-clockwise direction along with pressing of each of the plurality of nozzle heads downward, and the dispersion of one of the plurality of aerosols stored in each of the plurality of chambers are stopped when each of the plurality of nozzle heads is twisted in a reverse direction opposite to the anti-clockwise direction. Each of the plurality of nozzle heads include actuator components having a first actuator component associated with a first valve and a second actuator component associated with a second valve. Each of the at least two nozzle heads spray each of the plurality of aerosols when each of the actuator components triggers the opening of the first valve, the second valve, and so forth. The plurality of nozzle heads also includes a plurality of nozzles having spraying holes disposed at an upper portion for facilitating dispersion of each of the plurality of aerosols stored in each of the at least two chambers when one of the actuator component is pushed down by a user to spray one of the plurality of aerosols out of one of the at least two chambers, and stopping the dispensing of each of the plurality of aerosols stored in each of the at least two chambers when one of the plurality of nozzles twist in the anti-clockwise direction. The plurality of nozzle heads also includes a plurality of pipes associated with each of the plurality of nozzles to carry each of the plurality of aerosols associated with each of the plurality of two chambers. The container further includes a plurality of caps associated with the plurality of nozzle heads for covering each of the nozzle head by twisting in a first direction and uncovering the each of the plurality of nozzle heads by twisting in a second direction.

Embodiments in accordance with the present invention provide a single nozzle perfume dispensing container. The container includes body extending horizontally divided into at least two chambers separate from each other through a partition. The body is configured to contain at least two perfume products in each of the at least two chambers. The container also includes nozzle head associated with each of the at least two separate chambers for spraying each of the at least two perfume products when twisted in anti-clockwise direction along with pressing of the nozzle head downward, and the dispersion of each of the at least two perfume products stored in each of the at least two chambers are stopped when the nozzle head is twisted in a reverse direction opposite to the anti-clockwise direction. The nozzle head includes an actuator component associated with a valve for pumping the at least two perfume products inside the nozzle head, wherein the nozzle head is configured to spray each of the at least two perfumes simultaneously when the actuator component triggers the opening of the valve. The nozzle head also includes nozzle having a spraying hole disposed at an upper portion for facilitating dispersion of each of the at least two perfume products stored in each of the at least two chambers when the actuator component is pushed down by a user to spray the at least two perfume products out of the at least two chambers, and stopping the dispensing of each of the at least two perfume products stored in each of the at least two chambers when the nozzle twists in the anti-clockwise direction. The nozzle head also includes at least two pipes associated with the nozzle to carry each of the at least two perfume products associated with each of the at least two chambers. The container further includes a cap associated with the nozzle head for covering the nozzle head by twisting in a first direction and revealing the nozzle head by twisting in a second direction.

Embodiments of the present invention may provide a number of advantages depending on its particular configuration. First, embodiments of the present application provide a multiple nozzle perfume dispensing container. Next, embodiments of the present application provide an aerosol dispensing container. Next, embodiments of the present application provide a single nozzle perfume dispensing container.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates an exploded perspective view of a multiple nozzle perfume dispensing container, according to embodiments of the present invention disclosed herein;

FIG. 1B illustrates a schematic view of the multiple nozzle perfume dispensing container, according to embodiments of the present invention disclosed herein;

FIG. 2A illustrates an exploded perspective view of an aerosol dispensing container, according to embodiments of the present invention disclosed herein;

FIG. 2B illustrates a schematic view of the aerosol dispensing container, according to embodiments of the present invention disclosed herein;

FIG. 3A illustrates an exploded perspective view of a single nozzle perfume dispensing container, according to embodiments of the present invention disclosed herein; and

FIG. 3B illustrates a schematic view of the single nozzle perfume dispensing container, according to embodiments of the present invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

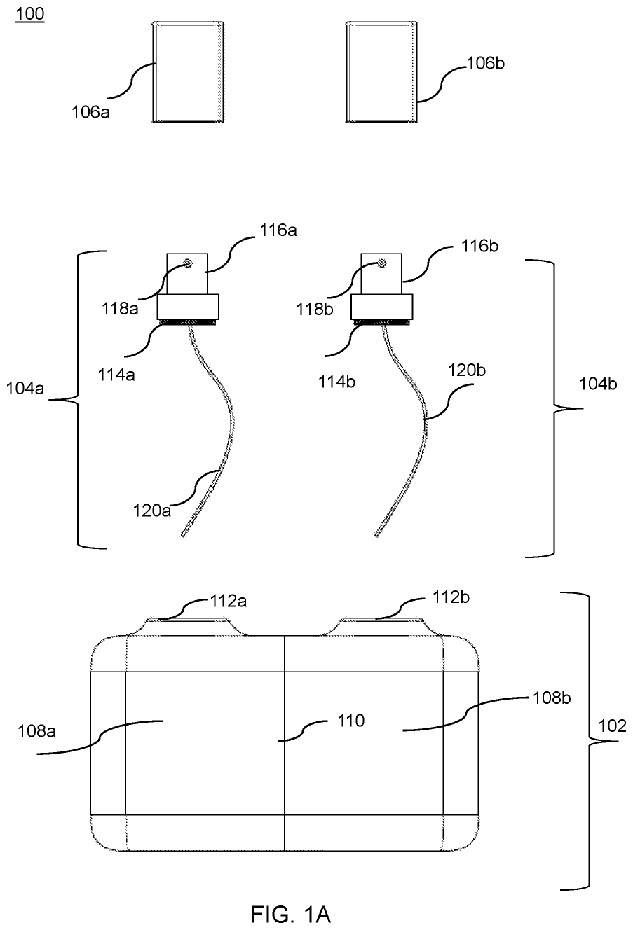

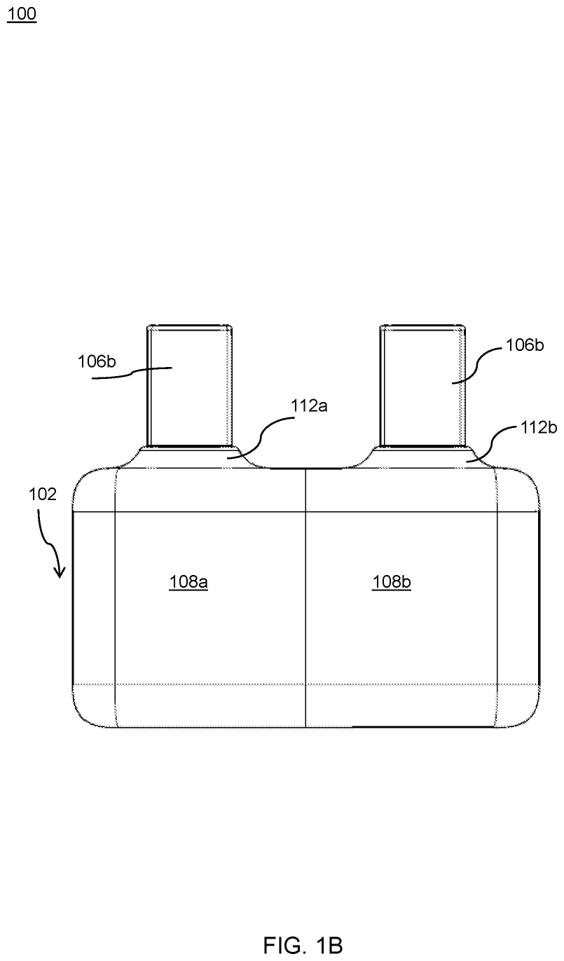

FIG. 1A an exploded perspective view of a multiple nozzle perfume dispensing container 100, according to embodiments of the present invention. The multiple nozzle perfume dispensing container 100 comprises a body 102, at least two nozzle heads 104a-104b (hereinafter referred to as the nozzles heads 104) and at least two caps 106 (hereinafter referred to as the caps 106), according to embodiments of the present invention.

According to embodiments of the present invention, the body 102 may be used for containing and refilling at least two perfume products. The body 102 may be extending horizontally and divided into at least two chambers 108a-108b (hereinafter referred to as the at least two chambers 108). The two chambers 108 may be separate from each other through a partition 110. The two chambers 108 may be configured to contain at least two perfume products in each of the at least two chambers 108. According to embodiments of the present invention, the body 102 may be made up of a material, such as, but not limited to, a transparent polymer, a hard polymer, an iron, an aluminum, a gun metal, a chromed steel, a stainless steel, and so forth. Embodiments of the present invention are intended to include or otherwise cover any type of the material for the body 102 of the multiple nozzle perfume dispensing container 100 including known, related art, and/or later developed technologies. The body 102 may hold the perfume inside without any leakage issue. According to embodiments of the present invention, the body 102 may be curved from edges with a defined thickness. In an embodiment of the present invention, the at least two chambers 108 may include two chambers in the body 102. In an embodiment of the present invention, the body 102 may include protruding parts 112a-112b (hereinafter referred to as the protruding parts 112) for holding each of the at least two nozzle heads.

According to embodiments of the present invention, the at least two nozzle heads 104a-104b (hereinafter referred to as the at least two nozzle heads 104) associated with each of the at least two separate chambers 108 for spraying each of the at least two perfume products when twisted in anti-clockwise direction along with pressing of each of the at least two nozzle heads 104 downward. Further, the dispersion of one of the at least two perfume products stored in each of the at least two chambers 108 may be stopped when one of the at least two nozzle heads 104 may be twisted in a reverse direction opposite to the anti-clockwise direction. Further, each of the at least two nozzle heads 104 may comprise actuator components 114a-114b (hereinafter referred to as the actuator components 114) having a first actuator component 114a associated with a first valve and a second actuator 114b component associated with a second valve. Each of the at least two nozzle heads 104 may spray each of the at least two perfume products when each of the actuator components 114 may trigger the opening of the first valve, the second valve, and so forth.

According to embodiments of the present invention, the at least two nozzle heads 104 may comprise at least two nozzles 116a-116b (hereinafter referred to as the at least two nozzles 116) having spraying holes 118a-118b (hereinafter referred to as the at least two nozzles 118) disposed at an upper portion for facilitating dispersion of each of the at least two perfume products stored in each of the at least two chambers 108 when one of the actuator components 114 is pushed down by a user to spray one of the at least two perfume products out of one of the at least two chambers 108. Moreover, stopping the dispensing of each of the at least two perfume products stored in each of the at least two chambers 108 may be performed when each of the at least two nozzles 116 twist in the anti-clockwise direction.

According to embodiments of the present invention, the at least two nozzle heads 104 may comprise at least two pipes 120a-120b (hereinafter referred to as the at least two pipes 120) associated with each of the at least two nozzles 118 to carry each of the at least two perfume products associated with each of the at least two chambers 108.

According to embodiments of the present invention, the multiple nozzle perfume dispensing container 100 may comprise the at least two caps 106 that may be associated with the at least two nozzle heads 104 for covering each of the nozzle heads 104 by twisting in a first direction and revealing the one of the at least two nozzle heads 104 by twisting in a second direction. In an embodiment of the present invention, the first direction may be a clockwise direction. In an embodiment of the present invention, the second direction may be an anti-clockwise direction. According to embodiments of the present invention, the two caps 106 may be made up of a material, such as, but not limited to, a transparent polymer, a hard polymer, an iron, an aluminum, a gun metal, a chromed steel, a stainless steel, and so forth. Embodiments of the present invention are intended to include or otherwise cover any type of the material for the two caps 106 including known, related art, and/or later developed technologies.

FIG. 1B illustrates a schematic view of the multiple nozzle perfume dispensing container 100, according to embodiments of the present invention. The body 102 of the multiple nozzle perfume dispensing container 100 may be attached to the at least two nozzle heads 104a-104b through the protruding parts 112a-112b. The body 102 may include the protruding parts 112a-112b for holding each of the at least two nozzle heads 104a-104b. In an embodiment of the present invention, the body 102 may be divided into a first chamber 108a, a second chamber 108b, and so forth. Further, the two nozzle heads 104a-104b may be covered by the at least two caps 120a-120b that may be associated with the at least two nozzle heads 104a-104b for covering each of the nozzle heads 104a-104b by twisting in a first direction. Furthermore, the two nozzle heads 104a-104b may be uncovered by twisting the at least two nozzle heads 104a-104b in a second direction. In an embodiment of the present invention, the first direction may be a clockwise direction. In an embodiment of the present invention, the second direction may be an anti-clockwise direction.

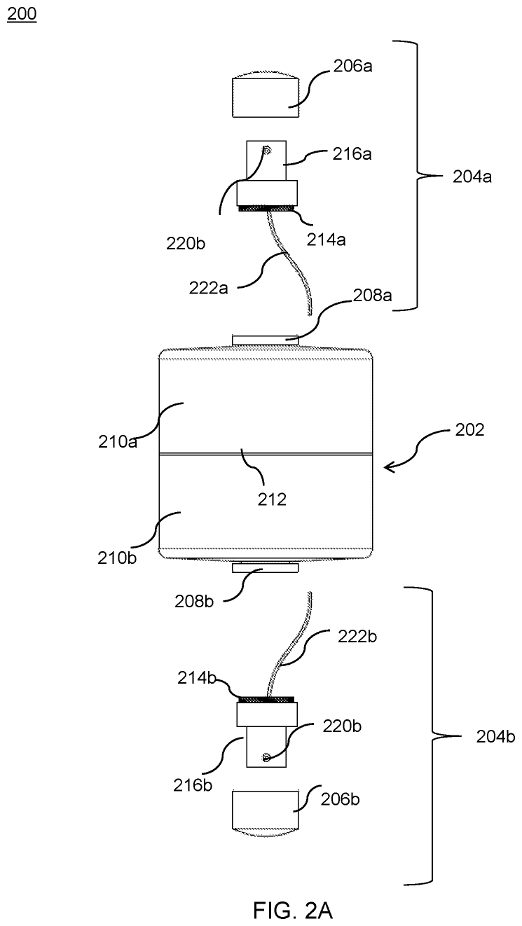

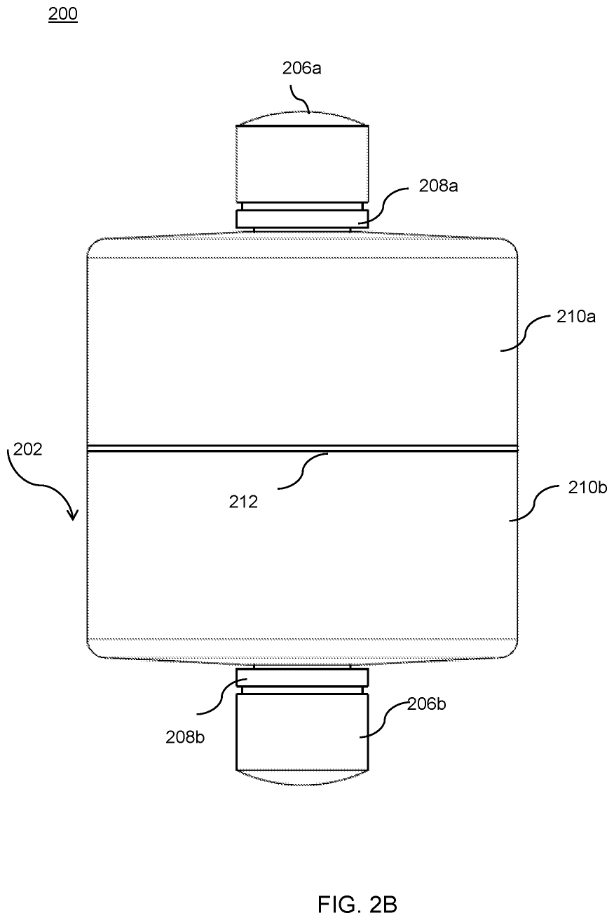

FIG. 2A illustrates an exploded perspective view of an aerosol dispensing container 200, according to embodiments of the present invention. The aerosol dispensing container 200 comprises a body 202, a plurality of nozzle heads 204a-204b (hereinafter referred to as the nozzle heads 204), and a plurality of caps 206a-206b (hereinafter referred to as the caps 206), according to embodiments of the present invention.

According to embodiments of the present invention, the body 202 may be extending vertically that may further include protruding parts 208a-208b. The body 202 may comprise a plurality of chambers 210a-210b that may be separate from each other through a partition 212. The plurality of chambers 210a-210b may comprise a first chamber 210a, a second chamber 210b, and so forth. In a preferred embodiment of the present invention, the plurality of chambers 210a-210b may be two chambers. In an embodiment of the present invention, the plurality of chambers 210a-210 may be configured to contain plurality of aerosols in each of the plurality of chambers 210a-210b. According to embodiments of the present invention, the aerosols may be, such as, but not limited to, air freshening agents, deodorants, insecticides, germicides, decongestants, perfumes, or any other known products suitable for dispersal in the form of particles or droplets suspended within a gas, and so forth. Embodiments of the present invention are intended to include or otherwise cover any type of the aerosols including known, related art, and/or later developed technologies. In preferred embodiments of the present invention, the aerosols may be perfumes. According to embodiments of the present invention, the body 202 may be made up of a material, such as, but not limited to, a transparent polymer, a hard polymer, an iron, an aluminum, a gun metal, a chromed steel, a stainless steel, and so forth. Embodiments of the present invention are intended to include or otherwise cover any type of the material for the body 202 of the aerosol dispensing device 200 including known, related art, and/or later developed technologies.

According to embodiments of the present invention, the nozzle heads 204 may be associated with each of the plurality of chambers 210a-210b for spraying each of the plurality of aerosols when twisted in anti-clockwise direction along with pressing of each of the plurality of nozzle heads 206 downward. Further, the dispersion of each of the plurality of aerosols stored in each of the plurality of chambers 210a-210b may be stopped when each of the plurality of nozzle heads 204 may be twisted in a reverse direction opposite to the anti-clockwise direction. In an embodiment of the present invention, the plurality of chambers 210a-210b includes two to five chambers.

According to embodiments of the present invention, the nozzle heads 204 may comprise actuator components 214a-214b (hereinafter referred to as the actuator components 214) having a first actuator component 214a associated with a first valve and a second actuator component 214b associated with a second valve. In an embodiment of the present invention, each of the plurality of nozzle heads 204 may spray each of the plurality of aerosols when each of the actuator components 214 may trigger the opening of the first valve, the second valve, and so forth.

According to embodiments of the present invention, the nozzle heads 204 may comprise a plurality of nozzles 216a-216b (hereinafter referred to as the nozzles 216) having spraying holes 220a-220b disposed at an upper portion for facilitating dispersion of each of the plurality of aerosols stored in each of the at least two chambers when one of the actuator components 216 may be pushed down by a user to spray one of the plurality of aerosols out of one of the at least two chambers 210. Moreover, the dispensing of each of the plurality of aerosols stored in each of the at least two chambers 210 may be stopped when one of the plurality of nozzles 216 may be twisted in the anti-clockwise direction. In an embodiment of the present invention, the plurality of nozzle heads 204 may include two to five nozzle heads

According to embodiments of the present invention, the nozzle heads 204 may comprise a plurality of pipes 222a-222b associated with each of the plurality of nozzles 216 to carry each of the plurality of aerosols associated with each of the plurality of two chambers 210. In an embodiment of the present invention, the plurality of pipes 222a-222b may include two to five pipes.

According to embodiments of the present invention, the plurality of caps associated with the plurality of nozzle heads 206 may covering each of the nozzle heads 204 by twisting in a first direction and uncovering the each of the plurality of nozzle heads 204 by twisting in a second direction. In an embodiment of the present invention, the first direction may be a clockwise direction. In an embodiment of the present invention, the second direction may be an anti-clockwise direction. According to embodiments of the present invention, the caps 206 may be made up of a material, such as, but not limited to, a transparent polymer, a hard polymer, an iron, an aluminum, a gun metal, a chromed steel, a stainless steel, and so forth. Embodiments of the present invention are intended to include or otherwise cover any type of the material for the caps 206 including known, related art, and/or later developed technologies.

FIG. 2B illustrates a schematic view of the aerosol dispensing container 200, according to embodiments of the present invention. The aerosol dispensing container 200 may comprise the body 202 that may be vertically extending and partitioned by a partitioner 210 into two chambers 210a-210b. In an embodiment of the present invention, the cap 206a may be fixed to the protruding part 208a of the body 202. In an embodiment of the present invention, the cap 206b may be fixed to the protruding part 208b of the body 202. According to embodiments of the present invention, the caps 206a-206b may be made up of a material, such as, but not limited to, a transparent polymer, a hard polymer, an iron, an aluminum, a gun metal, a chromed steel, a stainless steel, and so forth. Embodiments of the present invention are intended to include or otherwise cover any type of the material for the caps 206a-206b including known, related art, and/or later developed technologies. In an embodiment of the present invention, the plurality of caps may include two to five caps.

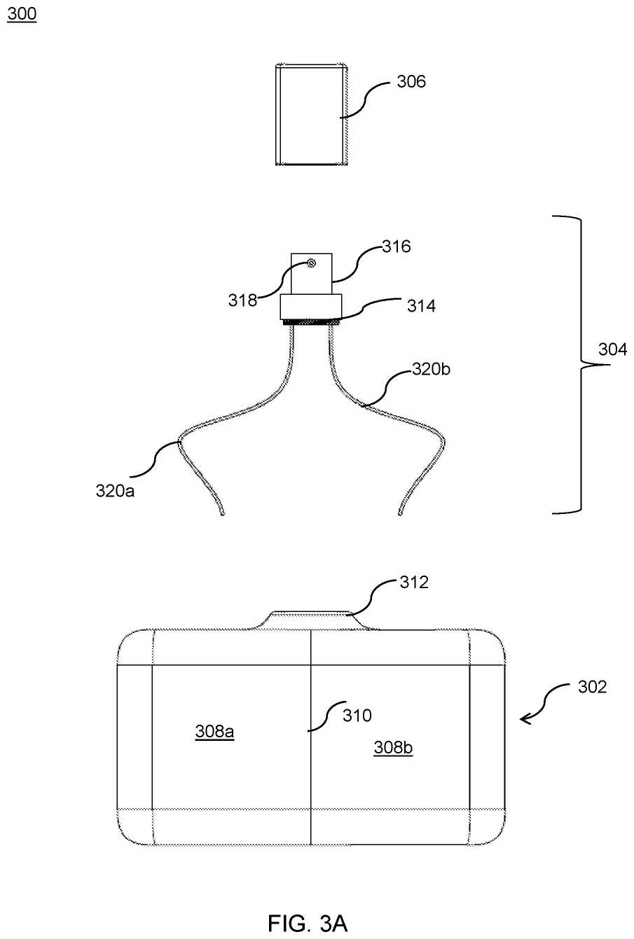

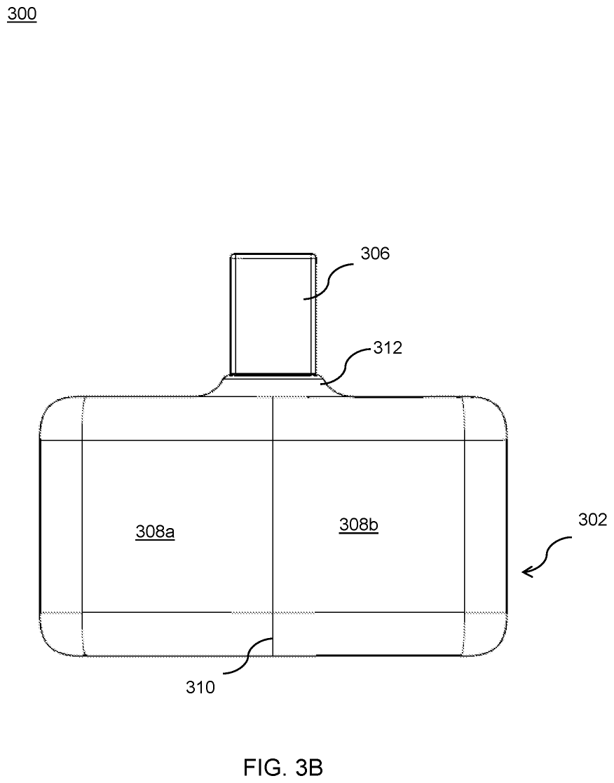

FIG. 3A illustrates an exploded perspective view of a single nozzle perfume dispensing container 300, according to embodiments of the present invention. The single nozzle dispensing container 300 comprises a body 302, a nozzle head 304, and a cap 306, according to embodiments of the present invention.

According to embodiments of the present invention, the body 302 may be extending horizontally that may be further divided into at least two chambers 308a-308b (hereinafter referred to as the two chambers 308) that may separate from each other through a partition 310. In an embodiment of the present invention, the body 302 may be configured to contain at least two perfume products in each of the at least two chambers 308. In an embodiment of the present invention, the body 302 may include a protruding part 312 for holding the nozzle head 304. In an embodiment of the present invention, the at least two chambers 308 may include two to five chambers.

According to embodiments of the present invention, the nozzle head 304 may be associated with each of the at least two separate chambers 308 for spraying each of the at least two perfume products when twisted in anti-clockwise direction along with pressing of the nozzle head 304 downward. Further, the dispersion of each of the at least two perfume products stored in each of the at least two chambers 308 may be stopped when the nozzle head 304 is twisted in a reverse direction opposite to the anti-clockwise direction. According to embodiments of the present invention, the nozzle head 304 may comprise an actuator component 314 that may be associated with a valve for pumping the at least two perfume products inside the nozzle head 304. In an embodiment of the present invention, the nozzle head 304 may be configured to spray each of the at least two perfumes simultaneously when the actuator component triggers the opening of the valve.

According to embodiments of the present invention, the nozzle head 304 may comprise a nozzle 316 having a spraying hole 316 disposed at an upper portion for facilitating dispersion of each of the at least two perfume products stored in each of the at least two chambers 308 when the actuator component is pushed down by a user to spray the at least two perfume products out of the at least two chambers 308, and stopping the dispensing of each of the at least two perfume products stored in each of the at least two chambers when the nozzle twists in the anti-clockwise direction. According to embodiments of the present invention, the nozzle head 304 may comprise at least two pipes 320a-320b that may be associated with the nozzle 316 to carry each of the at least two perfume products associated with each of the at least two chambers 308.

Further, the single nozzle perfume dispensing container 300 may comprise the cap 306 associated with the nozzle head 304 for covering the nozzle head 304 by twisting in a first direction. Further, the nozzle head 304 may be revealed by twisting in a second direction. In an embodiment of the present invention, the first direction may be a clockwise direction. In an embodiment of the present invention, the second direction may be an anti-clockwise direction. According to embodiments of the present invention, the cap 306 may be made up of a material, such as, but not limited to, a transparent polymer, a hard polymer, an iron, an aluminum, a gun metal, a chromed steel, a stainless steel, and so forth. Embodiments of the present invention are intended to include or otherwise cover any type of the material for the cap 306 including known, related art, and/or later developed technologies.

FIG. 3B illustrates a schematic view of the single nozzle perfume dispensing container 300, according to embodiments of the present invention. The body 302 of the single nozzle perfume dispensing container 300 may be divided into a first chamber 308b and a second chamber 308b. The body 302 may be attached with a nozzle head 304 that may further cover by twisting a cap 306 in a clockwise direction. Further, the nozzle head 304 may be revealed by twisting the cap 306 in the anti-clockwise direction.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

What is claimed is:

1. A multiple nozzle perfume dispensing container, the container comprising:
a body extending horizontally divided into at least two chambers separate from each other configured to contain at least two perfume products in each of the at least two chambers;
at least two nozzle heads associated with each of the at least two separate chambers for spraying each of the at least two perfume products when twisted in anti-clockwise direction along with pressing of each of the at least two nozzle heads downward, and the dispersion of one of the at least two perfume products stored in each of the at least two chambers are stopped when one of the at least two nozzle heads is twisted in a reverse direction opposite to the anti-clockwise direction, wherein each of the at least two nozzle heads comprise:
actuator components having a first actuator component associated with a first valve and a second actuator component associated with a second valve, wherein each of the at least two nozzle heads spray each of the at least two perfume products when each of the actuator components triggers the opening of the first valve, the second valve, or a combination thereof;
at least two nozzles having spraying holes disposed at an upper portion for facilitating dispersion of each of the at least two perfume products stored in each of the at least two chambers when one of the actuator component is pushed down by a user to spray one of the at least two perfume products out of one of the at least two chambers, and stopping the dispensing of each of the at least two perfume products stored in each of the at least two chambers when each of the at least two nozzles twist in the anti-clockwise direction; and
at least two pipes associated with each of the at least two nozzles to carry each of the at least two perfume products associated with each of the at least two chambers.
at least two caps associated with the at least two nozzle heads for covering each of the nozzle heads by twisting in a first direction and uncovering the one of the at least two nozzle heads by twisting in a second direction.

2. The container as claimed in claim 1, wherein the body is made up of a material that comprises a hard polymer, a transparent polymer, a stainless steel, or a combination thereof.

3. The container as claimed in claim 1, wherein the first direction is a clockwise direction.

4. The container as claimed in claim 1, wherein the second direction is an anti-clockwise direction.

5. The container as claimed in claim 1, wherein the body include protruding parts for holding each of the at least two nozzle heads.

6. An aerosol dispensing container, the container comprising:
a body extending vertically includes protruding parts and plurality of chambers separate from each other through a partition, wherein the plurality of chambers configured to contain plurality of aerosols in each of the plurality of chambers;
a plurality of nozzle heads associated with each of the plurality of chambers for spraying each of the plurality of aerosols when twisted in anti-clockwise direction along with pressing of each of the plurality of nozzle heads downward, and the dispersion of each of the plurality of aerosols stored in each of the plurality of chambers are stopped when each of the plurality of nozzle heads is twisted in a reverse direction opposite to the anti-clockwise direction, wherein each of the plurality of nozzle heads comprise:
actuator components having a first actuator component associated with a first valve and a second actuator component associated with a second valve, wherein each of the plurality of the nozzle heads spray each of the plurality of aerosols when each of the actuator components triggers the opening of the first valve, the second valve, or a combination thereof;
a plurality of nozzles having spraying holes disposed at an upper portion for facilitating dispersion of each of the plurality of aerosols stored in each of the at least two chambers when one of the actuator component is pushed down by a user to spray one of the plurality of aerosols out of one of the at least two chambers, and stopping the dispensing of each of the plurality of aerosols stored in each of the at least two chambers when one of the plurality of nozzles twist in the anti-clockwise direction; and
a plurality of pipes associated with each of the plurality of nozzles to carry each of the plurality of aerosols associated with each of the plurality of two chambers.
a plurality of caps associated with the plurality of nozzle heads for covering each of the nozzle head by twisting in a first direction and uncovering the each of the plurality of nozzle heads by twisting in a second direction.

7. The container as claimed in claim 1, wherein the body include protruding parts for holding each of the plurality of nozzle heads.

8. The container as claimed in claim 1, wherein the plurality of chambers includes two to five chambers.

9. The container as claimed in claim 1, wherein the plurality of nozzle heads includes two to five nozzle heads.

10. The container as claimed in claim 1, wherein the plurality of perfume aerosols includes two to five nozzle heads.

11. The container as claimed in claim 1, wherein the plurality of nozzles includes two to five nozzle heads.

12. The container as claimed in claim 1, wherein the plurality of pipes includes two to five pipes.

13. The container as claimed in claim 1, wherein the plurality of caps includes two to five caps.

14. The container as claimed in claim 1, wherein the body is made up of a material that comprises a hard polymer, a transparent polymer, a stainless steel, or a combination thereof.

15. The container as claimed in claim 1, wherein the first direction is a clockwise direction.

16. The container as claimed in claim 1, wherein the second direction is an anti-clockwise direction.

17. A single nozzle perfume dispensing container, the container comprising:
a body extending horizontally divided into at least two chambers separate from each other through a partition, wherein the body is configured to contain at least two perfume products in each of the at least two chambers;
a nozzle head associated with each of the at least two separate chambers for spraying each of the at least two perfume products when twisted in anti-clockwise direction along with pressing of the nozzle head downward, and the dispersion of each of the at least two perfume products stored in each of the at least two chambers are stopped when the nozzle head is twisted in a reverse direction opposite to the anti-clockwise direction, wherein the nozzle head comprises:
an actuator component associated with a valve for pumping the at least two perfume products inside the nozzle head, wherein the nozzle head is configured to spray each of the at least two perfumes simultaneously when the actuator component triggers the opening of the valve;
a nozzle having a spraying hole disposed at an upper portion for facilitating dispersion of each of the at least two perfume products stored in each of the at least two chambers when the actuator component is pushed down by a user to spray the at least two perfume products out of the at least two chambers, and stopping the dispensing of each of the at least two perfume products stored in each of the at least two chambers when the nozzle twists in the anti-clockwise direction; and
at least two pipes associated with the nozzle to carry each of the at least two perfume products associated with each of the at least two chambers.
a cap associated with the nozzle head for covering the nozzle head by twisting in a first direction and revealing the nozzle head by twisting in a second direction.

18. The container as claimed in claim 1, wherein the body include a protruding part for holding the nozzle head and the body is made up of a material that comprises a hard polymer, a transparent polymer, a stainless steel, or a combination thereof.

19. The container as claimed in claim 1, wherein the first direction is a clockwise direction and the second direction is an anti-clockwise direction.

20. The container as claimed in claim 1, wherein the at least two chambers include two to five chambers.
